(19) United States
(12) Patent Application Publication
(10) Pub. No.: US 2014/0159592 A1
(43) Pub. Date: Jun. 12, 2014

(54) LED LIGHT TUBE COMPATIBLE WITH LIGHT FIXTURE HAVING ELECTRONIC BALLAST OR MAGNETIC BALLAST

(71) Applicant: LUXUL TECHNOLOGY INCORPORATION, New Taipei City (TW)

(72) Inventors: Cheng-Hung PAN, New Taipei City (TW); Perng-Fei YUH, New Taipei City (TW)

(73) Assignee: LUXUL TECHNOLOGY INCORPORATION, New Taipei City (TW)

(21) Appl. No.: 14/075,706

(22) Filed: Nov. 8, 2013

(30) Foreign Application Priority Data
Dec. 11, 2012 (TW) 101146574

(51) Int. Cl. H05B 33/08

(52) U.S. Cl. CPC H05B 33/0809
USPC 315/187; 315/185 R

(57) ABSTRACT

The LED light tube compatible with a light fixture having an ballast has a translucent tube and an LED light bar mounted in the translucent tube. and having at least one waveform conversion circuit having multiple rectifier diodes and at least one LED light string connected to the at least one waveform conversion circuit, wherein a recovery time of each rectifier diode is under 1 μs; the ballast determines the at least one waveform conversion circuit and the at least one LED light string as low impedance loads, thus, the ballast does not output a high voltage AC power and burn the LED light tube; a recovery time of each rectifier diode is also short such that the LED light tube can endure a high frequency AC power outputted by the ballast. As such, the LED light tube is compatible with the light fixture.

The current application claims a foreign priority to the patent application of Taiwan No. 101146574 filed on Dec. 11, 2012.

### BACKGROUND OF THE INVENTION

1. Field of the invention

The present invention relates to an LED light tube and more particularly to an LED light tube compatible with a light fixture having an electronic ballast or a magnetic ballast.

2. Description of Related Art

In order to light a conventional fluorescent tube such as a T5 or T8 light tube, a conventional fluorescent tube light fixture usually has an electronic ballast or a magnetic ballast having a starter or without a starter. The conventional fluorescent tube has to be lighted by a high voltage, thus, the electronic ballast and the magnetic ballast both output a start-up voltage up to several hundred volt at a moment when the AC power is turned on. The ballast will send out high voltage when the fluorescent lamp is in high-impedance state during start-up. A traditional LED light tube with built-in driver is usually in high-impedance state during start-up. Therefore, a traditional LED light tube would be burned by the start-up voltage if it is directly mounted in a traditional fluorescent light fixture having an electronic ballast or a magnetic ballast.

A conventional linear LED light tube as shown in FIG. 6 has a bridge circuit 50 and an LED unit 60; the LED unit has a light string 61, and a driver circuit 62 in serial with the light string 61. The linear LED light tube is adapted for 110V or 220V constant-voltage AC power (60 Hz). When a power switch 12 is closed, a 110V constant-voltage AC power (60 Hz) is input such that the driver circuit 62 functions as a soft-start circuit, that is, the initially open-circuit LED unit 60 is gradually turned on by the driver circuit 62 and a conducting current of the LED unit 60 is gradually increased, and then a rated current is obtained and the LED string 61 is lighted up. With reference to FIG. 6, when the bridge circuit 50 is directly connected to an electronic ballast 11, because the recovery time of rectifier diodes 51 is too long or the driver circuit 62 is still in open-circuit at the moment when the power switch 12 becomes closed, the electronic ballast 11 regards the LED light tube as a high impedance load and outputs a high voltage AC power, and the LED light tube is burned by the high voltage AC power.

Furthermore, many light fixtures use electronic ballasts or magnetic ballasts to output high frequency AC powers to the conventional fluorescent tubes to solve problems of abnormal sound of the starters, flicker, and to improve efficiency of the tubes. However, even an LED light tube with a bridge rectifier can still be burned by the high frequency AC power outputted by the electronic ballast or the magnetic ballast, since low-speed rectifier diodes used in a normal bridge rectifier are only adapted for a 60 Hz low frequency AC power. When the low-speed rectifier diodes are connected to a high frequency AC power over 20 KHz, the low-speed rectifier diodes are burned by the high frequency AC power due to long recovery time of the low-speed rectifier diodes. In addition, when the conventional fluorescent tube is lighted by the high voltage and high frequency AC power outputted by the electronic ballast, the conventional fluorescent tube becomes a low impedance load, such that a current of the AC power outputted by the electronic ballast becomes a constant current to drive the low impedance fluorescent tube. However, a driver circuit of an LED light tube is designed to be adapted for an AC mains power, and a constant voltage of the AC line power is 110V or 220V such that the driver circuit is not able to convert the AC power with the constant current outputted by the electronic ballast into a driver power of the LED light tube.

In conclusion, currently, an LED light tube cannot be directly mounted in a light fixture whether the LED light tube is a switching LED light tube or a linear LED light tube, unless the LED light tube has a power protection circuit or a conversion circuit corresponding to the AC power outputted by the electronic ballast. The above-mentioned defect is one of the reasons why the LED light tubes are still not universal nowadays.

### SUMMARY OF THE INVENTION

The main objective of the invention is to provide an LED light tube that is compatible with a light fixture having an electronic ballast or a magnetic ballast.

The LED light tube comprises a translucent tube having two side openings, two electric plugs and an LED light bar mounted in the translucent tube. The two electric plugs are respectively mounted on the two side openings of the translucent tube and adapted for being electrically connected to AC output terminals of an electronic ballast or a magnet ballast. The LED light bar has at least one waveform conversion circuit and at least one LED light string; the at least one waveform conversion circuit is electrically connected to the two electric plugs and has multiple rectifier diodes; wherein a recovery time of each rectifier diode is under 1 μs; the at least one LED light string has two terminals respectively connected to output terminals of the at least one waveform conversion circuit; wherein each one of the at least one LED light string comprises multiple LED units connected in series.

Another LED light tube in accordance with the present invention comprises a translucent tube having two side openings, two electric plugs, and an LED light bar mounted in the translucent tube. The two electric plugs are respectively mounted on the two side openings of the translucent tube and adapted for being electrically connected to AC output terminals of an electronic ballast or a magnet ballast. The LED light bar has a waveform conversion circuit having a first light string and a second light string; wherein the second light string is reversely connected in parallel with the first light string; wherein the first light string comprises multiple first LED units connected in series, and the first LED units are mounted on the LED light bar in an array; the second light string comprises multiple second LED units connected in series, and the second LED units are mounted on the LED light bar in an array.

The LED light tube in accordance with the present invention can be directly mounted in a light fixture having an electronic ballast or a magnetic ballast without other driver circuit besides the at least one waveform conversion circuit. The electronic ballast having features of high power factor, high efficiency and full voltage is used as a driver circuit of the LED light tube. Therefore, a user does not need to re-wire the light fixture to by-pass the electronic ballast when the user replaces a conventional fluorescent tube with the LED light tube. The at least one LED light string is connected in series with a power loop of the at least one waveform conversion circuit when the power switch is closed, and thus, the electronic ballast determines the at least one LED light string as a low impedance load and outputs a low voltage AC power. Furthermore, with the feature of short recovery time of the rectifier diodes of the at least one waveform conversion circuit, the at least one waveform conversion circuit converts the constant current of the high frequency AC power outputted by the electronic ballast to a DC power, such that the at least one LED light string can use the DC power directly. In conclusion, the LED light tube in accordance with the present invention can directly use the high frequency AC power outputted by the electronic ballast and also avoids being burned by the high frequency AC power outputted by the electronic ballast.

### BRIEF DESCRIPTION OF THE DRAWINGS

FIG. 1 is an exploded perspective view of an LED light tube in accordance with the present invention and a conventional fluorescent tube light fixture;

FIG. 2 is a circuit diagram of a first embodiment of the LED light tube in accordance with the present invention;

FIG. 3 is a circuit diagram of a second embodiment of the LED light tube in accordance with the present invention;

FIG. 4 is a circuit diagram of a third embodiment of the LED light tube in accordance with the present invention;

FIG. 5 is a circuit diagram of a fourth embodiment of the LED light tube in accordance with the present invention; and

FIG. 6 is a circuit diagram of a conventional linear LED light tube connected to an electronic ballast.

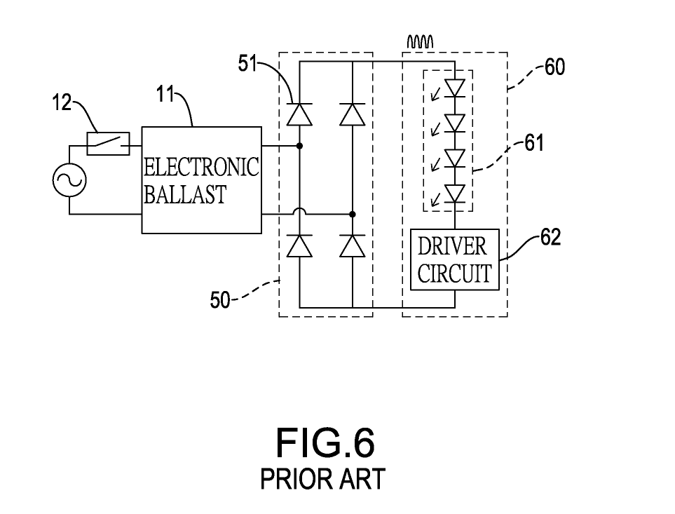

### DETAILED DESCRIPTION OF THE PREFERRED EMBODIMENTS

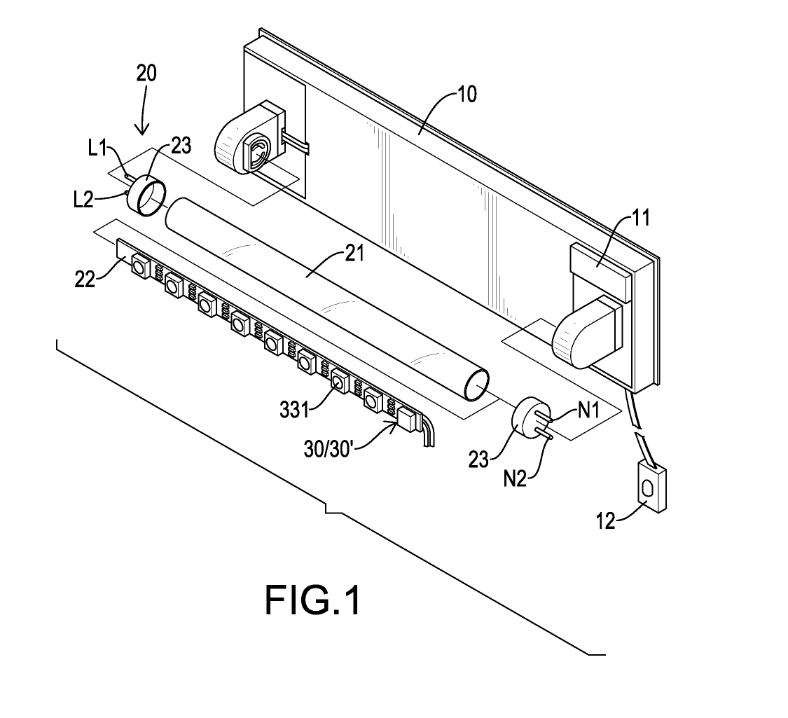

With reference to FIG. 1, an exploded perspective view of an LED light tube 20 in accordance with the present invention mounted in a conventional fluorescent tube light fixture 10 is shown; wherein the light fixture 10 has an electronic ballast 11 and the electronic ballast 11 is connected to an AC line power (60 Hz) through a power switch 12. When the power switch 12 is turned on, the LED light tube 20 forms a power loop with the power switch 12 to light the LED light tube 20. The LED light tube 20 comprises a translucent tube 21, an LED light bar 22 and two electric plugs 23.

The translucent tube 21 has two side openings.

The LED light bar 22 is mounted in the translucent tube 21; and

The electric plugs 23 are respectively mounted on the two side openings of the translucent tube 21 and electrically connected to the LED light bar 22. The electric plugs 23 are adapted for being inserted to the fixture 10 and electrically connected to AC output terminals of an electronic ballast or a magnet ballast.

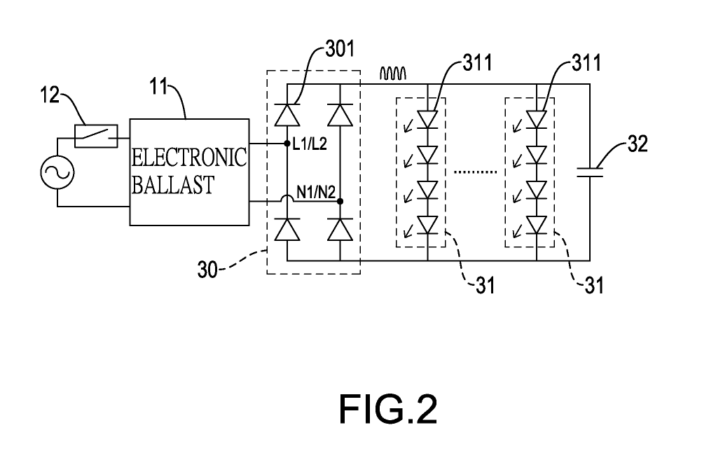

With further reference to FIG. 2, a start-up process of a first preferred embodiment of an LED light tube 20 in accordance with the present invention being mounted in the fixture 10 having the electronic ballast 11 is shown. The LED light bar 22 further comprises a waveform conversion circuit 30 and at least one LED light string 31.

The waveform conversion circuit 30 has two input terminals respectively connected to the two electric plugs 23, and multiple rectifier diodes 301. A recovery time of each rectifier diode 301 is under 1 μs, which is obtained by taking a frequency of the electronic ballast 11, which is 40 KHZ, as a basis and taking 1/25 of a cycle of the electronic ballast 11 to avoid overheat. In a preferred embodiment, the waveform conversion circuit 30 is a half-bridge circuit or a full-bridge circuit.

The at least one LED light string 31 has two terminals respectively connected to two output terminals of the waveform conversion circuit 30. Each one of the at least one LED light string 31 comprises multiple LED units 311 connected in series.

One of the electric plugs 23 comprises a first electrode pin terminal having two electrode pins L1/L2, and the other electric plug 23 comprises a second electrode pin terminal having two electrode pins N1/N2. The electric plug 23 having the two electrode pins L1/L2 is the bi-pin connector in a T8 or a T5 tube. The other electric plug 23 having the two electrode pins N1/N2 is another bi-pin connector in the T8 or the T5 tube. In the first preferred embodiment, the two electrode pins L1/L2 of the first electrode pin terminal is shorted and connected to one of the input terminals of the waveform conversion circuit 30, and two electrode pins N1/N2 of the second electrode pin terminal is shorted and connected to the other input terminal of the waveform conversion circuit 30. Furthermore, an electric capacitor 32 is connected in parallel with the LED light string 31. The electric capacitor 32 is charged when the AC power goes up from low voltage to high voltage, and then releases the charge when the AC power goes down from high voltage to low voltage to solve a problem of stroboscopic effect when the LED light string 31 starts to light up. In general, a frequency of the stroboscopic effect is high (20 KHZ to 40 KHZ) and the stroboscopic effect can be eliminated by the electric capacitor 32. A preferred capacitance of the electric capacitor 32 is between 1 uF and 20 uF due to the high frequency of the electronic ballast 11. Only a low capacitance of the electric capacitor 32 is needed.

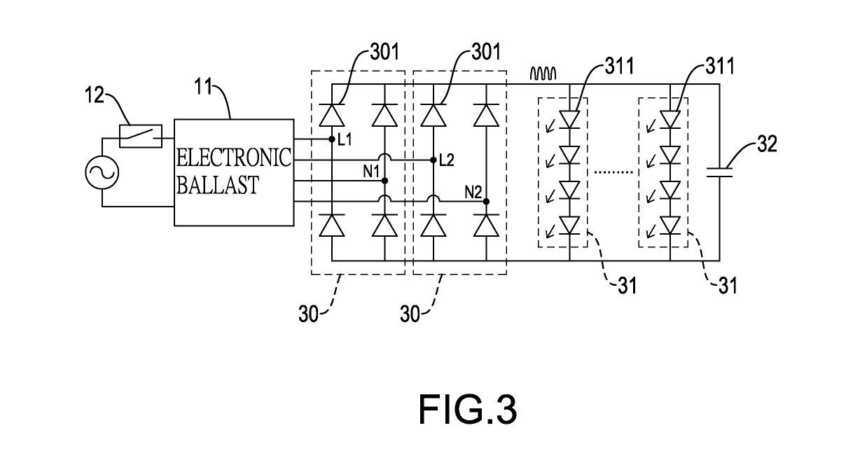

With reference to FIGS. 1 and 3, a second preferred embodiment of an LED light tube 20 in accordance with the present invention is shown; wherein the LED light tube 20 is also mounted in the fixture 10 having the electronic ballast 11. A difference between the second preferred embodiment and the first preferred embodiment is that the LED light tube 20 of the second preferred embodiment further comprises a second waveform conversion circuit 30, that is, the LED light tube 20 of the second preferred embodiment comprises a first waveform conversion circuit 30 and a second waveform conversion circuit 30. Wherein two input terminals of the first waveform conversion circuit 30 are respectively connected to the electrode pin L1 of the first electrode pin terminal and the electrode pin N1 of the second electrode pin terminal. Two input terminals of the second waveform conversion circuit 30 are respectively connected to the electrode pin L2 of the first electrode pin terminal and the electrode pin N2 of the second electrode pin terminal.

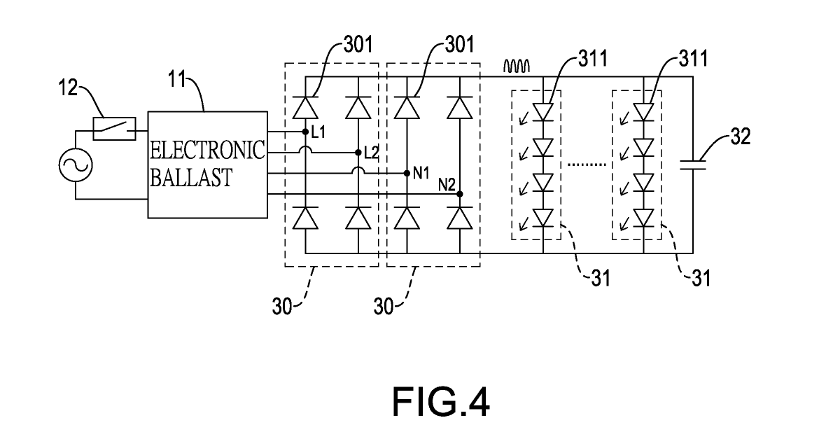

With reference to FIGS. 1 and 4, a third preferred embodiment of an LED light tube 20 in accordance with the present invention is shown; wherein the LED light tube 20 is also mounted in the fixture 10 having the electronic ballast 11. A difference between the third preferred embodiment and the first preferred embodiment is that the LED light tube 20 of the third preferred embodiment further comprises a second waveform conversion circuit 30, that is, the LED light tube 20 of the second preferred embodiment comprises a first waveform conversion circuit 30 and a second waveform conversion circuit 30. Wherein two input terminals of the first waveform conversion circuit 30 are respectively connected to the electrode pins L1 and L2 of the first electrode pin terminal. Two input terminals of the second waveform conversion circuit 30 are respectively connected to the electrode pins N1 and N2 of the second electrode pin terminal.

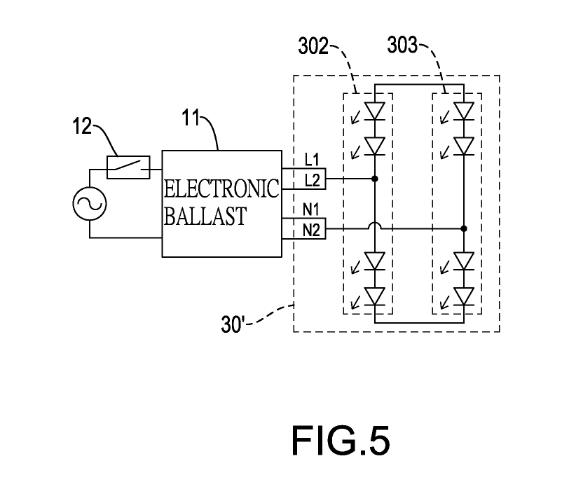

With reference to FIG. 5, a fourth preferred embodiment of an LED light tube 20 in accordance with the present invention is shown; wherein the LED light tube 20 is also mounted in the light fixture 10 having the electronic ballast 11. In the third preferred embodiment, the waveform conversion circuit 30′ comprises a first light string 302 and a second light string 303; wherein the second light string 303 is reversely connected in parallel with the first light string 302. The first light string 302 comprises multiple first LED units connected in series, and the first LED units are mounted on the LED light bar 22 in an array; the second light string 303 comprises multiple second LED units connected in series, and the second LED units are mounted on the LED light bar 22 in an array. Generally, a recovery time of an LED unit is under than 1 μs. Therefore, in the third preferred embodiment, the waveform conversion circuit 30′ is directly formed with the LED units and the LED units can lighted up with the high frequency AC power. In conclusion, the waveform conversion circuit 30 and the at least one LED light string 31 in the first preferred embodiment are merged together as the lightable waveform conversion circuit 30′.

A quantity of the LED string and a quantity of the LED units in the above preferred embodiments are based on wattage of an LED light tube, and wattage of an LED light tube can be obtained by the following formula:

W=I×V_{F};

I is a rated output current of an electronic ballast, and rated output currents vary depending on manufacturer and wattage of different electronic ballasts; and

V_{F} is a sum of forward bias voltage drops of all LED units.

Therefore, when designing the LED light tube in accordance with the present invention, if a single LED light string cannot endure the current outputted by the electronic ballast, multiple LED light strings are connected in parallel until the LED light strings can endure the current outputted by the electronic ballast. Furthermore, wattage of an LED light tube is based on a quantity of the LED units connected in series, that is, the wattage of the LED light tube can be adjusted by the quantity of the LED units connected in series as desired. For example, in order to manufacture a 20W LED light tube when a current outputted by the electronic ballast is 250 mA, the quantity of the LED units connected in series is adjusted and the V_{F} of the LED light tube becomes 80V to manufacture a 20W LED light tube, such that a luminance of the LED light tube equals a luminance of a 20W conventional fluorescent tube. When the V_{F} is adjusted to 160V, a 40W LED light tube is manufactured and a luminance of the LED light tube is twice as the luminance of the LED light tube having V_{F}=80V, and when the V_{F} is 120V, a 30W LED light tube is manufactured.

When the power switch 12 is turned on, the electronic ballast 11 obtains a low frequency AC power from the line power. The at least one LED light string 31 is connected in series with the waveform conversion circuit 30, 30′, such that the at least one LED light string 31 and the waveform conversion circuit 30, 30′ are determined as low impedance loads by the electronic ballast 11, thus, the electronic ballast 11 does not output a high voltage AC power. Furthermore, the LED light tubes 20 of the first and the third preferred embodiments use the rectifier diodes 301 or the LED units 311 having short recovery times, such that the LED light tubes 20 in accordance with the present invention can endure the high frequency AC power outputted by the electronic ballast 11 without burning the LED light tubes 20.

In conclusion, the LED light tube in accordance with the present invention is compatible with a light fixture having an electronic ballast or a magnetic ballast, and the ballast is used as a driver circuit of the LED light tube. The electronic ballast has features of high power factor, high efficiency and full voltage, thus, a luminance efficiency of the LED light tube is increased. The LED light tube only comprises a high-speed bridge circuit, such that a structure of the LED light tube is simplified to lower cost. The LED light tube in accordance with the present invention solves problems derived from mounting an LED light tube in a conventional fluorescent tube light fixture having an electronic ballast to be compatible with the fixture. The user can easily replace a conventional fluorescent tube by directly mounted the LED light tube in the light fixture. Therefore, the LED light tube in accordance with the present invention contributes to a popularization of LED light tubes.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An LED light tube compatible with a light fixture having an electronic ballast or a magnetic ballast, the LED light tube comprising:
a translucent tube having two side openings;
two electric plugs respectively mounted on the two side openings of the translucent tube and adapted for being electrically connected to the AC output terminals of an electronic ballast or a magnet ballast; and
an LED light bar mounted in the translucent tube and comprising:
at least one waveform conversion circuit electrically connected to the two electric plugs and having multiple rectifier diodes; wherein a recovery time of each rectifier diode is under 1 μs; and
at least one LED light string having two terminals respectively connected to output terminals of the at least one waveform conversion circuit; wherein each one of the at least one LED light string comprises multiple LED units connected in series.

2. The LED light tube as claimed in claim 1, wherein the at least one waveform conversion circuit is a full-bridge circuit.

3. The LED light tube as claimed in claim 1, wherein the LED light tube further comprises an electric capacitor connected in parallel with the at least one LED light string.

4. The LED light tube as claimed in claim 2, wherein the LED light tube further comprises an electric capacitor connected in parallel with the at least one LED light string.

5. The LED light tube as claimed in claim 1, wherein the LED light bar comprises a waveform conversion circuit, wherein one of the electric plugs comprises a first electrode pin terminal, and the other electric plug comprises a second electrode pin terminal; the first and the second electrode pin terminals are connected to the waveform conversion circuit.

6. The LED light tube as claimed in claim 2, wherein the LED light bar comprises a waveform conversion circuit, wherein one of the electric plugs comprises a first electrode pin terminal, and the other electric plug comprises a second electrode pin terminal; the first and the second electrode pin terminals are connected to the waveform conversion circuit.

7. The LED light tube as claimed in claim 3, wherein the LED light bar comprises a waveform conversion circuit, wherein one of the electric plugs comprises a first electrode pin terminal, and the other electric plug comprises a second electrode pin terminal; the first and the second electrode pin terminals are connected to the waveform conversion circuit.

8. The LED light tube as claimed in claim 4, wherein the LED light bar comprises a waveform conversion circuit, wherein one of the electric plugs comprises a first electrode pin terminal, and the other electric plug comprises a second electrode pin terminal; the first and the second electrode pin terminals are connected to the waveform conversion circuit.

9. The LED light tube as claimed in claim 1, wherein the LED light bar comprises two waveform conversion circuits, wherein one of the electric plugs comprises a first electrode pin terminal, and the other electric plug comprises a second electrode pin terminal; the first and the second electrode pin terminals each respectively have two pins; one of the pins of the first electrode pin terminal and one of the pins of the second electrode pin terminal are connected to one of the waveform conversion circuits; the other pin of the first electrode pin terminal and the other pin of the second electrode pin terminal are connected to the other waveform conversion circuit.

10. The LED light tube as claimed in claim 2, wherein the LED light bar comprises two waveform conversion circuits, wherein one of the electric plugs comprises a first electrode pin terminal, and the other electric plug comprises a second electrode pin terminal; the first and the second electrode pin terminals each respectively have two pins; one of the pins of the first electrode pin terminal and one of the pins of the second electrode pin terminal are connected to one of the waveform conversion circuits; the other pin of the first electrode pin terminal and the other pin of the second electrode pin terminal are connected to the other waveform conversion circuit.

11. The LED light tube as claimed in claim 3, wherein the LED light bar comprises two waveform conversion circuits, wherein one of the electric plugs comprises a first electrode pin terminal, and the other electric plug comprises a second electrode pin terminal; the first and the second electrode pin terminals each respectively have two pins; one of the pins of the first electrode pin terminal and one of the pins of the second electrode pin terminal are connected to one of the waveform conversion circuits; the other pin of the first electrode pin terminal and the other pin of the second electrode pin terminal are connected to the other waveform conversion circuit.

12. The LED light tube as claimed in claim 4, wherein the LED light bar comprises two waveform conversion circuits, wherein one of the electric plugs comprises a first electrode pin terminal, and the other electric plug comprises a second electrode pin terminal; the first and the second electrode pin terminals each respectively have two pins; one of the pins of the first electrode pin terminal and one of the pins of the second electrode pin terminal are connected to one of the waveform conversion circuits; the other pin of the first electrode pin terminal and the other pin of the second electrode pin terminal are connected to the other waveform conversion circuit.

13. The LED light tube as claimed in claim 1, wherein the LED light bar comprises two waveform conversion circuits, wherein one of the electric plugs comprises a first electrode pin terminal, and the other electric plug comprises a second electrode pin terminal; the first and the second electrode pin terminals each respectively have two pins; the two pins of the first electrode pin terminal are connected to one of the waveform conversion circuits; the two pins of the second electrode pin terminal are connected to the other waveform conversion circuit.

14. The LED light tube as claimed in claim 2, wherein the LED light bar comprises two waveform conversion circuits, wherein one of the electric plugs comprises a first electrode pin terminal, and the other electric plug comprises a second electrode pin terminal; the first and the second electrode pin terminals each respectively have two pins; the two pins of the first electrode pin terminal are connected to one of the waveform conversion circuits; the two pins of the second electrode pin terminal are connected to the other waveform conversion circuit.

15. The LED light tube as claimed in claim 3, wherein the LED light bar comprises two waveform conversion circuits, wherein one of the electric plugs comprises a first electrode pin terminal, and the other electric plug comprises a second electrode pin terminal; the first and the second electrode pin terminals each respectively have two pins; the two pins of the first electrode pin terminal are connected to one of the waveform conversion circuits; the two pins of the second electrode pin terminal are connected to the other waveform conversion circuit.

16. The LED light tube as claimed in claim 4, wherein the LED light bar comprises two waveform conversion circuits, wherein one of the electric plugs comprises a first electrode pin terminal, and the other electric plug comprises a second electrode pin terminal; the first and the second electrode pin terminals each respectively have two pins; the two pins of the first electrode pin terminal are connected to one of the waveform conversion circuits; the two pins of the second electrode pin terminal are connected to the other waveform conversion circuit.

17. An LED light tube compatible with a light fixture having an electronic ballast or a magnetic ballast, the LED light tube comprising:
a translucent tube having two side openings;
two electric plugs respectively mounted on the two side openings of the translucent tube and adapted for being electrically connected to AC output terminals of an electronic ballast or a magnet ballast; and
an LED light bar mounted in the translucent tube and comprising:
a waveform conversion circuit electrically connected to the two electric plugs, and having a first light string and a second light string; wherein the second light string is reversely connected in parallel with the first light string; wherein the first light string comprises multiple first LED units connected in series, and the first LED units are mounted on the LED light bar in an array; the second light string comprises multiple second LED units connected in series, and the second LED units are mounted on the LED light bar in an array.

18. The LED light tube as claimed in claim 17, wherein one of the electric plugs comprises a first electrode pin terminal, and the other electric plug comprises a second electrode pin terminal; the first and the second electrode pin terminals are connected to the waveform conversion circuit.
